(19) United States
(12) Patent Application Publication
(10) Pub. No.: US 2012/0054455 A1
(43) Pub. Date: Mar. 1, 2012

(54) Non-Uniform Interleaving Scheme In Multiple Channel DRAM System

(75) Inventors: Feng Wang, San Diego, CA (US); Shiqun Gu, San Diego, CA (US); Jonghae Kim, San Diego, CA (US); Matthew Michael Nowak, San Diego, CA (US)

(73) Assignee: QUALCOMM Incorporated, San Diego, CA (US)

(21) Appl. No.: 12/872,458

(22) Filed: Aug. 31, 2010

(51) Int. Cl. G06F 12/06

(52) U.S. Cl. 711/157; 711/E12.079

(57) ABSTRACT

A non-uniform interleaving scheme in a multiple channel DRAM system comprises associating memory data with a memory address, associating address zones to predetermined ranges of memory addresses and associating predetermined interleaving granularities with the address zones. Memory data is interleaved across two or more memory channels such that a predetermined interleaving granularity is applied to each address zone.

### REFERENCE TO CO-PENDING APPLICATIONS FOR PATENT

The present application for patent is related to the following co-pending U.S. patent applications:
LOAD BALANCING SCHEME IN MULTIPLE CHANNEL DRAM SYSTEMS by Feng Wang et al., having Attorney Docket No. 090685, filed concurrently herewith, assigned to the assignee hereof, and expressly incorporated by reference herein.

### FIELD OF DISCLOSURE

Disclosed embodiments are related to multiple channel Dynamic Random Access Memory (DRAM) systems. More particularly, the embodiments are related to non-uniform interleaving schemes in multiple channel DRAM systems.

### BACKGROUND

DRAM systems are among the most common and least expensive memory systems used in computers. They are smaller in size, compared to Static Random Access Memory (SRAM) systems, and their small size enables the manufacture of high density DRAM systems. However, conventional DRAM systems are also slower than SRAM, and must be periodically refreshed in order to maintain the data stored in the memory. Hence, one of the significant considerations in controlling DRAM is the speed at which data can be read from or written to the memory.

A common technique to increase the access speed to and from the DRAM is called interleaving. The memory system is divided into two or more memory channels which can be accessed in parallel. Data in contiguously addressed memory locations are distributed among the memory channels such that contiguously addressed data words may be accessed from different memory channels in parallel, rather than waiting for a single memory channel to service each request in sequence. Thus, a memory request from a master device such as a computer's processing unit can be performed by a memory controller in such an interleaved system more rapidly than if these words were stored sequentially in a single memory channel. Interleaving improves the utilization of memory bandwidth available in a memory system.

Data can flow across each memory channel independently and in parallel to other memory channels in interleaved memory access schemes. Memory systems may also be designed such that each memory channel is mapped to certain memory addresses and data can be transmitted to/from a memory channel based on the memory address mapping.

Memory addresses in interleaved memory channels are commonly mapped such that a first channel is assigned a predetermined number of consecutively addressed memory locations. A second channel is assigned the predetermined number of next consecutively addressed memory locations, and so on. Thus, memory locations which are separated by the predetermined number reside in separate memory channels and hence, they may be accessed in parallel. The predetermined number is commonly referred to as the granularity of the interleaving scheme.

For example, consider an interleaved DRAM system which includes four memory channels. For the sake of simplicity, the data words in sequential memory locations are assumed to be addressed by memory addresses 0, 1, 2, 3, 4 . . . . The data words may be distributed among the four memory channels such that the first memory channel includes data words with addresses 0, 4, 8, . . . ; the second memory channel includes data words with addresses 1, 5, 9, . . . ; and similarly the fourth memory channel includes data words with addresses 3, 7, 11, . . . . It can be seen that the interleaving granularity is 1 in this example. Thus, memory locations 0, 1, 2 and 3 can be accessed in parallel through the four memory channels, because they reside in separate memory channels.

Depending on the application executed in a master device, requiring memory access, the traffic on a particular memory channel may increase drastically at any given time. As a result, that memory channel may get choked, stalling further access to the associated memory channel. In the example above, with four memory channels, if consecutive instructions in a particular application require sequential accesses to every fourth data word in the memory, then all the memory requests are routed to a single memory channel, causing that memory channel to be choked. Other memory channels may be relatively free in this scenario, but their available bandwidth is not effectively utilized. Sometimes, exceptions or interrupts may also cause accesses to a particular memory channel to stall. Hence, a uniform granularity for all applications may not be advantageous, as the performance of some applications may be severely affected based on the chosen granularity.

To mitigate problems associated with congestion, load balancing schemes are commonly employed to remap memory addresses assigned to a particular memory channel in order to redistribute and balance the traffic load among different memory channels. A common load balancing scheme is “uniform interleaving”. The granularity of interleaving is uniform across the entire address space in uniform interleaving.

As a result, applications which are optimally suited for a granularity value that is different from the chosen value; will suffer from performance degradation. There is therefore, a need for interleaved memory systems with a granularity that is not uniform across the entire address range. Further, since the uniform interleaving approach is static in nature, and relies heavily on the access patterns, real time congestions on memory channels are not effectively handled by POR load balancing schemes.

### SUMMARY

Exemplary embodiments are directed to systems and method for non-uniform interleaving schemes in multiple channel DRAM systems.

For example, exemplary embodiments are directed to A multiple channel Dynamic Random Access Memory (DRAM) system comprising memory data addressable with a memory address, address zones comprising predetermined ranges of memory addresses, predetermined interleaving granularities associated with the address zones, and the memory data interleaved across two or more memory channels according to a non-uniform interleaving scheme, wherein a predetermined interleaving granularity is applied to each address zone.

Another exemplary embodiment is directed to a method for non-uniform interleaving in a multiple channel DRAM system, the method comprising associating memory data with a memory address, associating address zones to predetermined ranges of memory addresses, associating predetermined interleaving granularities with the address zones; and interleaving the memory data across two or more memory channels such that a predetermined interleaving granularity is applied to each address zone.

Yet another exemplary embodiment is directed to a DRAM system comprising addressable means for storing memory data, the addressable means divided into address zones, wherein interleaving granularities are associated with the address zones, channel means for accessing the memory data, and means for interleaving the memory data across two or more channel means according to a non-uniform interleaving scheme, wherein a predetermined interleaving granularity is applied to each address zone.

A further exemplary embodiment is directed to a method for non-uniform interleaving in a multiple channel DRAM system, the method comprising step for associating memory data with a memory address, step for associating address zones to predetermined ranges of memory addresses, step for associating predetermined interleaving granularities with the address zones; and step for interleaving the memory data across two or more memory channels such that a predetermined interleaving granularity is applied to each address zone.

### BRIEF DESCRIPTION OF THE DRAWINGS

The accompanying drawings are presented to aid in the description of embodiments of the invention and are provided solely for illustration of the embodiments and not limitation thereof.

FIG. 1 illustrates a conventional multiple channel DRAM system, interleaved with a fixed granularity, and comprising a plurality of bus masters coupled to a plurality of slave memory controllers through an interconnect system.

FIG. 2 illustrates a multiple channel DRAM system with non-uniform interleaving granularity across the address space, according to an exemplary embodiment.

FIG. 3 illustrates a mapping table, associating interleaving granularity with discrete address zones in the memory address space of an exemplary embodiment.

FIG. 4 is a flow chart illustrating the interleaving scheme according to an exemplary embodiment.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more'processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

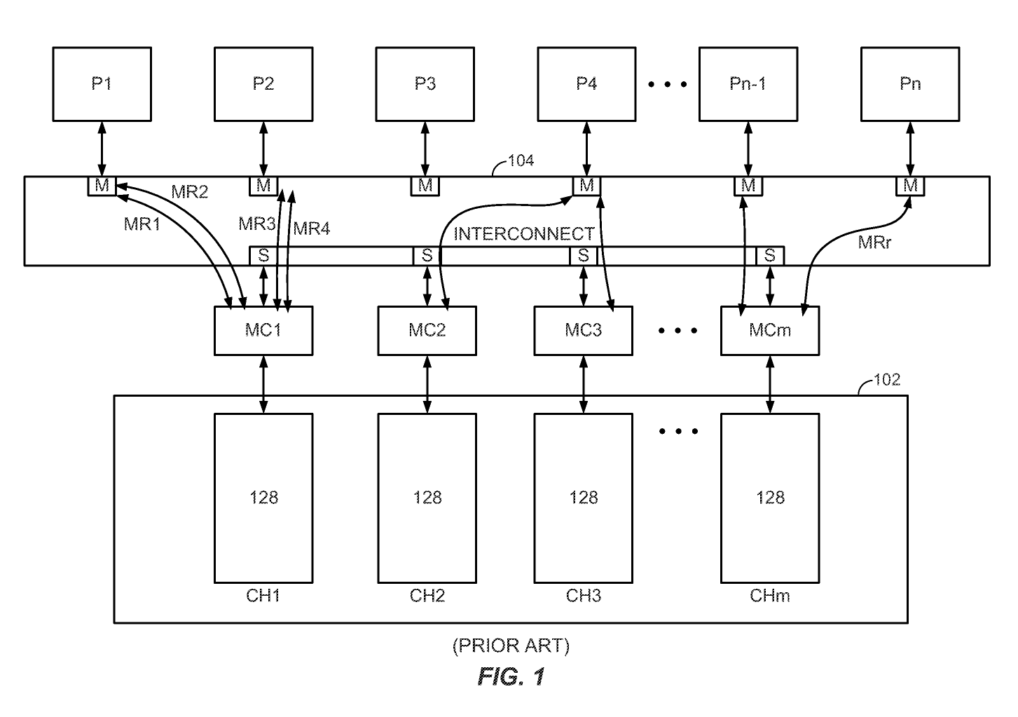

FIG. 1 illustrates a conventional interleaved DRAM system with uniform granularity. DRAM memory 102 may be a Through Silicon Stacking (TSS) stacked DDR. Interconnect 104 is a switching network that selectively interconnects multiple bus masters to multiple slaves via a dedicated, point-to-point interface. “n” bus masters P1-Pn may represent computer systems or peripheral devices capable of executing applications which require access to DRAM memory 102. “m” memory channels are accessed through “m” channels CH1-CHm in DRAM memory 102. Access to the “m” channels CH1-CHm is controlled by “m” memory controllers MC1-MCm.

The memory controllers MC1-MCm are slave devices which receive requests for memory access from bus masters P1-Pn, and respond accordingly. The value of m may not be equal to n. Several bus masters may request a memory access to a single channel at any given point in time. Further, less than all memory channels may be utilized at any given point in time. The maximum amount of data which can be transmitted through a memory channel at any given point in time is referred to as the bandwidth of the channel. For optimum performance of the memory system, it is desirable that the bandwidth utilized in each memory channel is balanced across all the memory channels.

The interleaving granularity in FIG. 1 is 128, which is uniform across the entire address space. Commonly, memory addresses refer to a byte address. Thus, the first 128 bytes of data in the address space may be accessed from memory channel MC1, the second 128 bytes from memory channel MC2, and so on for m 128 bytes of data. The (m+1)^{th} 128 bytes of data may be looped back to memory channel MC1, and so on.

Exemplary embodiments recognize that bus masters P1-Pn often have predictable address patterns for memory accesses. For example, the memory accesses of applications associated with a display device may conform to a very regular address pattern. Such master devices lend themselves to an optimal interleaving granularity that is derived from the address patterns. However, the central processing unit may execute many different types of applications, and the address patterns may be irregular. Bus masters which exhibit irregular address patterns may benefit from a low granularity value. Moreover, bus masters P1-Pn may be associated with predetermined address “zones” in the address space. Hence, the interleaving granularity may be varied across the address space in a DRAM system, such that each address zone associated with a bus master is interleaved with an optimum granularity for the associated bus master.

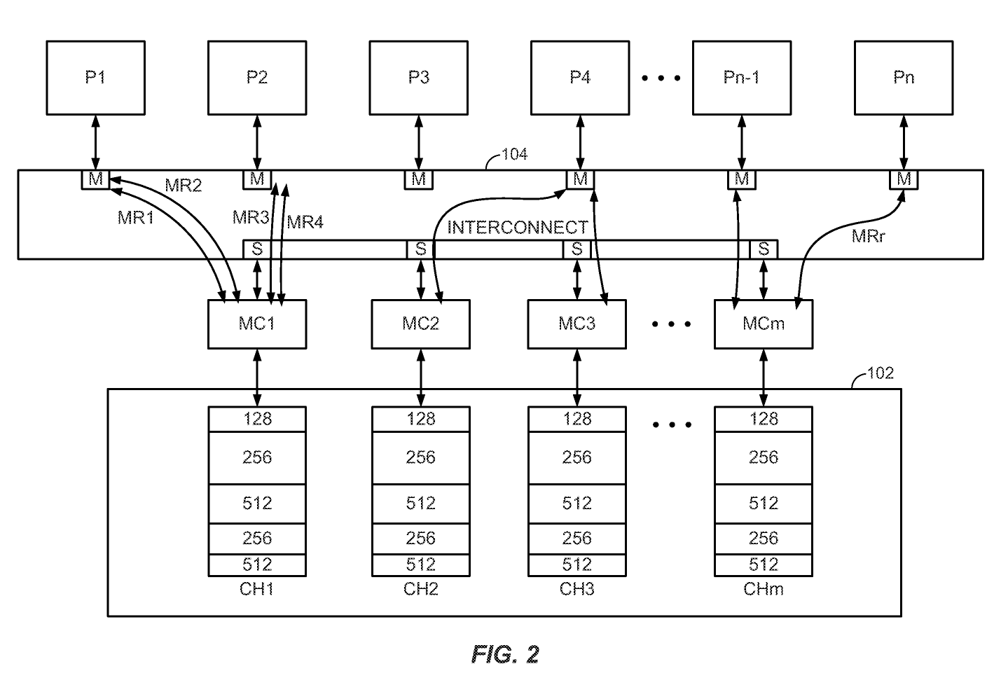

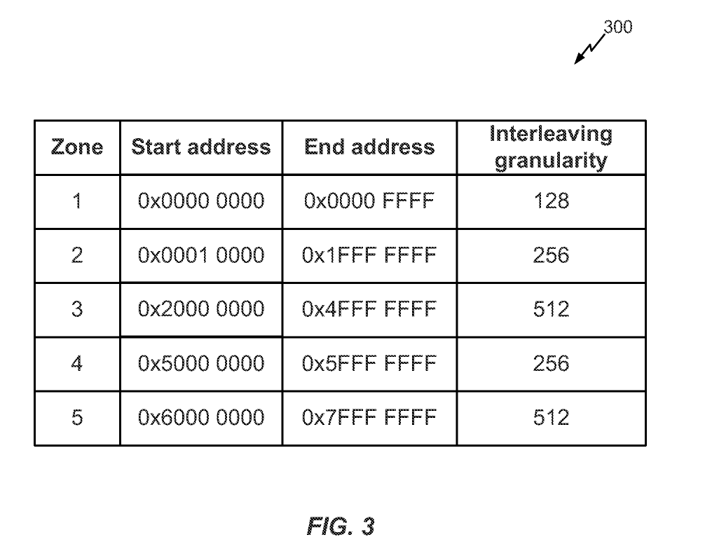

FIG. 2 illustrates an exemplary embodiment with non-uniform interleaving. The granularity for interleaving in each address zone, as defined by start and end address values, is depicted in table 300 of FIG. 3. Address zone 1 has an interleaving granularity of 128, zones 2 and 4 are interleaved at a granularity of 256 and zones 3 and 5 at 512. The granularity in each of these zones is determined based on the manner in which bus masters P1-Pn are mapped to the address zones 1-5 in an exemplary memory system.

FIG. 3 illustrates a mapping table, associating interleaving granularity with discrete address zones in the memory address space of an exemplary embodiment. When a bus master makes a memory request to a particular address through interconnect 104, an address decoder (not shown) references the mapping table 300 shown in FIG. 3. The address decoder determines the interleaving granularity based on the address zone within which the particular address lies. Since the number, in, of interleaved memory channels is known, the address decoder determines the memory channel associated with the particular address according to the formula:

Memory channel number=(particular address/interleaving granularity) & (m−1)+1

The memory request for the particular address is then sent to the appropriate memory controller associated with the calculated memory channel number to service the request.

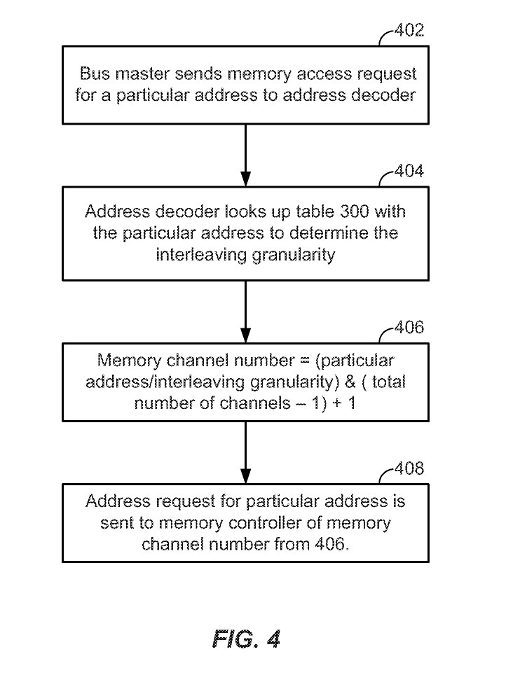

The process steps described above are depicted in FIG. 4. In block 402, a bus master sends memory access request for a particular address to the address decoder. In block 404, the address decoder looks up table 300 to determine the interleaving granularity. The memory channel number wherein the particular address is contained is determined in block 406, and the request is forwarded to the corresponding memory controller in block 408.

The interleaving scheme described in exemplary embodiments with non-uniform granularity is less dependent on access patterns than the conventional approach, because the interleaving scheme is adaptive to memory access characteristics of bus masters, which are commonly predictable. Thus, optimal interleaving granularity is associated with different masters. Exemplary embodiments improve load balancing, and consequently, the available memory bandwidth in the multi channel DRAM system is utilized very efficiently.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an embodiment of the invention can include a computer readable media embodying a method for load balancing in a multiple channel DRAM system. Accordingly, the invention is not limited to illustrated examples and any means for performing the functionality described herein are included in embodiments of the invention.

Embodiments of the disclosure may be suitably employed in any device which includes active integrated circuitry including memory and on-chip circuitry for test and characterization.

The foregoing disclosed devices and methods are typically designed and are configured into GDSII and GERBER computer files, stored on a computer readable media. These files are in turn provided to fabrication handlers who fabricate devices based on these files. The resulting products are semiconductor wafers that are then cut into semiconductor die and packaged into a semiconductor chip. The chips are then employed in devices described above.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A multiple channel Dynamic Random Access Memory (DRAM) system comprising:
memory data addressable with a memory address;
address zones comprising predetermined ranges of memory addresses;
predetermined interleaving granularities associated with the address zones; and
the memory data interleaved across two or more memory channels according to a non-uniform interleaving scheme, wherein a predetermined interleaving granularity is applied to each address zone.

2. The DRAM system of claim 1 further comprising:
memory controllers associated with the memory channels; and
bus masters coupled to the memory controllers via an interconnect system, such that the bus masters are associated with master ports and the memory controllers are associated with slave ports of the interconnect system.

3. The DRAM system of claim 1, wherein a first interleaving granularity associated with a first address zone is not equal to a second interleaving granularity associated with a second address zone.

4. The DRAM system of claim 2, further comprising a table, wherein the table comprises a mapping between the predetermined interleaving granularities and the associated address zones.

5. The DRAM system of claim 4, further comprising an address decoder configured to look up the table with a memory address to determine the address zone and predetermined interleaving granularity associated with the memory address.

6. The DRAM system of claim 5, further comprising logic to determine a memory channel number corresponding to the memory channel which comprises memory data associated with the memory address.

7. The DRAM system of claim 6, further comprising logic to send a request for the memory address to the memory controller associated with the memory channel corresponding to the memory channel number.

8. The DRAM system of claim 1 integrated in at least one semiconductor die.

9. The DRAM system of claim 1 integrated into a device, selected from the group consisting of a set top box, music player, video player, entertainment unit, navigation device, communications device, personal digital assistant (PDA), fixed location data unit, and a computer.

10. A method for non-uniform interleaving in a multiple channel Dynamic Random Access Memory (DRAM) system, the method comprising:
associating memory data with a memory address;
associating address zones to predetermined ranges of memory addresks;
associating predetermined interleaving granularities with the address zones; and
interleaving the memory data across two or more memory channels such that a predetermined interleaving granularity is applied to each address zone.

11. The method of claim 10 further comprising:
associating memory controllers with the memory channels; and
coupling bus masters to the memory controllers via an interconnect system, such that the bus masters are associated with master ports and the memory controllers are associated with slave ports of the interconnect system.

12. The method of claim 10, wherein a first interleaving granularity value associated with a first address zone is not equal to a second interleaving granularity value associated with a second address zone.

13. The method of claim 11, further comprising, configuring a table, wherein the table includes a mapping between the predetermined interleaving granularities and the associated address zones.

14. The method of claim 11, further comprising, configuring an address decoder to look up the table with a memory address to determine the address zone and predetermined interleaving granularity associated with the memory address.

15. The method of claim 14, further comprising, determining a memory channel number corresponding to the memory channel which comprises memory data associated with the memory address.

16. The method of claim 15, further comprising sending a request for the memory address to the memory controller associated with the memory channel corresponding to the memory channel number.

17. The method of claim 10, wherein the DRAM system is integrated in at least one semiconductor die.

18. The method of claim 10, wherein the DRAM system is integrated into a device, selected from the group consisting of a set top box, music player, video player, entertainment unit, navigation device, communications device, personal digital assistant (PDA), fixed location data unit, and a computer.

19. A Dynamic Random Access Memory (DRAM) system comprising:
addressable means for storing memory data, the addressable means divided into address zones, wherein interleaving granularities are associated with the address zones;
channel means for accessing the memory data; and
means for interleaving the memory data across two or more channel means according to a non-uniform interleaving scheme, wherein a predetermined interleaving granularity is applied to each address zone.

20. The DRAM system of claim 19 further comprising:
means for associating controller means with the channel means; and
means for coupling bus masters to the controller means via an interconnect means, such that the bus masters are associated with master ports and the controller means are associated with slave ports of the interconnect means.

21. The DRAM system of claim 20, wherein a first interleaving granularity associated with a first address zone is not equal to a second interleaving granularity associated with a second address zone.

22. The DRAM system of claim 20, further comprising table means, wherein the table means comprises a mapping between the predetermined interleaving granularities and the associated address zones.

23. The DRAM system of claim 22, further comprising decoder means configured to access the table means with a memory address to determine the address zone and interleaving granularity associated with the memory address.

24. The DRAM system of claim 23, further comprising first logic means to determine a memory channel number corresponding to the channel means which comprises memory data associated with the memory address.

25. The DRAM system of claim 24, further comprising second logic means to send a request for the memory address to the controller means associated with the channel means corresponding to the memory channel number.

26. The DRAM system of claim 19 integrated in at least one semiconductor die.

27. The DRAM system of claim 19 integrated into a device, selected from the group consisting of a set top box, music player, video player, entertainment unit, navigation device, communications device, personal digital assistant (PDA), fixed location data unit, and a computer.

28. A method for non-uniform interleaving in a multiple channel Dynamic Random Access Memory (DRAM) system, the method comprising:
step for associating memory data with a memory address;
step for associating address zones to predetermined ranges of memory addresses;
step for associating predetermined interleaving granularities with the address zones; and
step for interleaving the memory data across two or more memory channels such that a predetermined interleaving granularity is applied to each address zone.

29. The method of claim 28 further comprising:
step for associating memory controllers with the memory channels; and
step for coupling bus masters to the memory controllers via an interconnect system, such that the bus masters are associated with master ports and the memory controllers are associated with slave ports of the interconnect system.

30. The method of claim 28, wherein a first interleaving granularity value associated with a first address zone is not equal to a second interleaving granularity value associated with a second address zone.

31. The method of claim 29, further comprising, step for configuring a table, wherein the table includes a mapping between the predetermined interleaving granularities and the associated address zones.

32. The method of claim 29, further comprising, step for configuring an address decoder to look up the table with a memory address to determine the address zone and predetermined interleaving granularity associated with the memory address.

33. The method of claim 32, further comprising, step for determining a memory channel number corresponding to the memory channel which comprises memory data associated with the memory address.

34. The method of claim 33, further comprising step for sending a request for the memory address to the memory controller associated with the memory channel corresponding to the memory channel number.

35. The method of claim 28, wherein the DRAM system is integrated in at least one semiconductor die.

36. The method of claim 28, wherein the DRAM system is integrated into a device, selected from the group consisting of a set top box, music player, video player, entertainment unit, navigation device, communications device, personal digital assistant (PDA), fixed location data unit, and a computer.
